(19) United States
(12) Patent Application Publication
(10) Pub. No.: US 2015/0360597 A1
(43) Pub. Date: Dec. 17, 2015

(54) RENEWABLE FIBER TRIM LAMINATE

(71) Applicant: LEAR CORPORATION, Southfield, MI (US)

(72) Inventors: Ashford Allen GALBREATH, Troy, MI (US); Asad S. ALI, Troy, MI (US)

(21) Appl. No.: 14/728,239

(22) Filed: Jun. 2, 2015

Related U.S. Application Data
(60) Provisional application No. 62/011,745, filed on Jun. 13, 2014.

(51) Int. Cl. B60N 2/70; B60N 2/58; B32B 38/10; B32B 5/26; B32B 37/06; B32B 37/10

(52) U.S. Cl. CPC B60N 2/70; B32B 37/06; B32B 37/10; B32B 38/10; B60N 2/7017; B32B 5/26; B60N 2/58; B32B 2038/008

(57) ABSTRACT

A trim laminate for covering a cushion component, said trim laminate comprising: a trim cover having a top surface and a bottom surface; and a fibrous layer secured to the bottom surface of the trim cover, the fibrous layer comprising nano-crystalline cellulose fiber and synthetic fiber.

### CROSS-REFERENCE TO RELATED APPLICATIONS

This application claims the benefit of U.S. provisional application Ser. No. 62/011,745 filed Jun. 13, 2014, the disclosures of which are incorporated in their entirety by reference herein.

### TECHNICAL FIELD

The present disclosure relates to a trim laminate that is useful in automotive interior applications.

### BACKGROUND

Automobile manufacturers and suppliers continually strive to improve the aesthetic appeal, crafted appearance and hand feel of vehicle interior components. Such considerations have influenced the design of vehicle interior and seating trim including the main seating back, cushion, headrest, armrest and console components to name a few. Environmental concerns place additional manufacturing pressures on vehicle design, with the amount of renewable and recycled content being of paramount importance.

Many automobile interior components include resinous foams, such as polyurethane. A significant use for such resinous foams is found in vehicle trim laminates as a backing for the fabric, leather and/or vinyl trim cover to impart a relatively soft feel to the interior component which is desirable to consumers' touch. Although these traditional resinous foams work reasonably well, they are not renewable resource-derived, can contain levels of chemical emissions that can fog the interior glass, can require the addition of expensive chemical flame retardants that are facing regulatory limitations, do not contain recycled content, and are derived from non-renewable petroleum sources.

Accordingly, there is a need for improved automobile components, such as trim laminates, that provide a cushioning comfort, are durable enough to continue to perform during the vehicle life cycle, are renewable resource-derived, include recycled content, and do not contain chemicals or chemical derivatives that are emitted into the cabin air or during manufacturing or handling.

### SUMMARY

The present disclosure solves one or more problems of the prior art by providing in at least one embodiment a trim laminate for automotive interior components. In at least one embodiment, the trim laminate contains a fibrous layer comprising renewable nano-crystalline cellulosic fibers, and synthetic fiber, such as recycled polyester. In at least one embodiment, substantially more than half of the fibrous layer of the trim laminate is made from recycled content and derived from a renewable source.

### BRIEF DESCRIPTION OF THE DRAWINGS

FIG. 1 is an exposed perspective view of a vehicle seat having a renewable fiber pad disposed over a fibrous cushion component; and

FIG. 2 is a cross section view of the seat in FIG. 1 along line 2-2.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

Except in the examples, or where otherwise expressly indicated, all numerical quantities in this description indicating amounts of material or conditions of reaction and/or use are to be understood as modified by the word “about” in describing the broadest scope of the disclosure.

It is also to be understood that this disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

Throughout this application, where publications are referenced, the disclosures of these publications in their entireties are hereby incorporated by reference into this application to more fully describe the state of the art to which this disclosure pertains.

The term “caliper thickness” as used herein means the perpendicular separation between the two surfaces of a sheet.

In an embodiment of the present disclosure, a trim laminate for use in various automotive interior components is provided. In at least one embodiment, the trim laminate comprises a fibrous layer secured to a trim cover. The trim laminate is secured over a cushion element, which is typically disposed over a frame, however does not necessarily have to be. The trim laminate is advantageously incorporated in head restraints, vehicle seats, armrests, and other interior vehicle components. As set forth in the background section, prior art versions of such trim laminates generally include a resinous foam (e.g., polyurethane foam) to provide cushioning properties. In accordance with at least one embodiment, the trim laminate of the present embodiment includes an environmentally friendly fibrous layer that substantially entirely replaces polyurethane foams as set forth below in more detail.

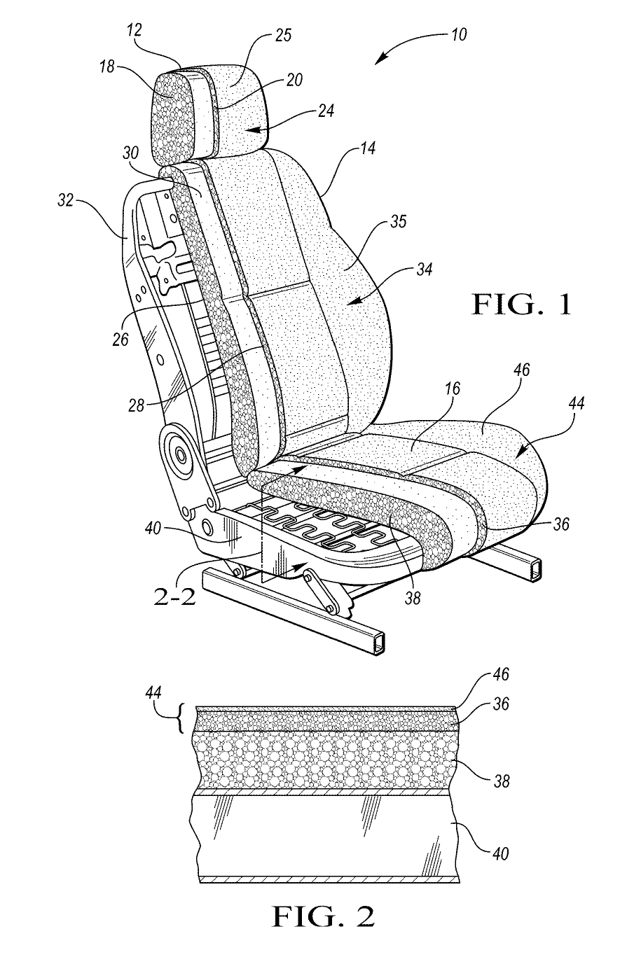

With reference to FIG. 1, a perspective view of a vehicle seat 10 including multiple trim laminates having a fibrous layer incorporating nano-crystalline cellulose fibers is provided. In at least one embodiment, the nano-crystalline cellulose fibers comprise lyocell fibers. In at least another embodiment, the nano-crystalline cellulose fibers comprise cellulose fibers having a fibrillar fiber structure. In still yet another embodiment, cellulose nanofibers form both crystalline and amorphous areas within the nano-fibrils. “Nano” describes the diameter size of the particle or fiber and is the equivalent of one-billionth of a meter. A “nano-particle” or “nano-fibril” is a microscopic particle or fiber of matter that is measured on the nanoscale, usually one that measures less than 100 nanometers. A fibril is a small or fine fiber or filament. A “nano-fibral is a small or fine fiber that is measured on a nanometer scale. In at least certain embodiments, the cellulose fibers of the fibrous layer are formed using a series of nano-fibrils that have both crystalline and fibril regions measurable on a nanoscale.

Vehicle seat 10 includes head restraint 12, vehicle seat back 14 and vehicle seat bottom 16. Head restraint 12 includes cushion 18. A trim laminate 24 including a fibrous layer 20 is positioned over cushion 18. Vehicle seat back 14 includes seat back cushion 26 that overlays seat back frame 32. A trim laminate 34 overlays cushion 26. The trim laminate 34 includes a fibrous layer 28 secured to a trim cover 35. Fibrous layer 28 includes cellulose fibers as set forth above. Similarly, vehicle seat bottom 16 includes a trim laminate 44 including a fibrous layer 36 positioned over cushion 38, with a trim cover 46 positioned over the fibrous layer 36. Cushion 38 is positioned over seat bottom frame 40.

While the trim laminates 24, 34 and 44 will be described and shown as being of the same material and construction, it should be understood that the trim laminates can differ from each other. For instance, one of the trim laminates 24, 34, and 44 can be made in accordance with an embodiment disclosed herein, whereas the others of trim laminates 24, 34 and 44 can be made of a different embodiment and/or of a trim cover not having a fibrous layer having a cellulose layer.

With reference to FIG. 2, a schematic cross section of the seat bottom 16 is provided showing a representative trim laminate. As can be readily seen in this variation, the trim laminate 44 is a multi-component structure. The cushion 38 is supported on the seat bottom frame 40. The trim laminate 44 is disposed over the cushion 38. In at least certain embodiments, the trim laminate 44 comprises fibrous layer 36 secured under trim cover 46.

Fibrous layer 36 includes a mixture of nano-crystalline cellulose fibers and synthetic fibers. As set forth above, trim laminate 44 is positioned over cushion 38. Advantageously, substantially more than 50 weight percent of the fibrous layer 36 is recyclable and derived from a renewable source. Examples of a renewable source are nano-crystalline fiber derived from cellulose extracts from trees. This source of materials is to be contrasted to petroleum-derived raw materials used in polyurethane trim laminates and foam cushion elements.

Cover 46 acts to secure cushion 38 in place while providing an aesthetically pleasing appearance and feel. Cover 46 is formed from any suitable material used in vehicle interior applications. Examples of such materials include, but are not limited to, non-woven fabrics, woven fabrics, leather, plastic sheets, vinyl sheets, and combinations thereof. Cover 46 can be secured to fibrous layer 36 via any suitable manner, such as stitching and/or adhesive.

The cushions can each independently have any suitable size, shape and configuration, however in at least one embodiment, have an average thickness of 0.5 to 4 cm, and in at least another embodiment of 1 to 3 cm. The cushions can each independently comprise any suitable cushion material, such as a suitable resilient polymer. In at least one embodiment, suitable cushion materials will have a density of 1.5 to 4.5 pcf, in another embodiment of 2.0 to 3.75 pcf, and in yet other embodiments of 2.7 to 3.0 pcf. Density of the cushion material can be measured by ASTM test method No. D3574.

In at least certain embodiments, the cushion material comprises conventional polyurethane foam, soy-based foam, silicone, thermoplastic olefins, thermoplastic urethanes, and/or natural oil-based expanded polyurethanes and the like. In at least one embodiment, because of its environmentally friendly nature, soy-based polyurethane is preferred. Soy-based polyurethane can be made with any suitable soy-based polyols, such as those available, but not necessarily limited to, from Bayer, Urethane Soy Systems Corporation, and Dow Chemical. Any suitable soy-based polyurethane may be used, however in at least one embodiment, suitable soy-based polyurethanes include, but are not necessarily limited to those available from Lear Corporation.

The trim cover materials may each independently include any non-cloth material such as leather, vinyl, polyurethane film, and TPU trim material, as are known in the art.

Embodiments of the present disclosure include one or more fibrous layers include cellulose fibers. For example, fibrous layers 20, 28 and 36 described above all include cellulose fibers. U.S. patent Application No. 2008/0050565 provides examples of useful materials for the fiber section. The entire disclosure of this patent application is hereby incorporated by reference. Examples of useful cellulose fibers include, but are not limited to, cellulose acetate and regenerated cellulose (e.g., viscose rayon).

In certain embodiments, the cellulose fiber is made from wood pulp cellulose, which is harvested from tree-farmed trees. The tree farms have been established on land unsuitable for food crops or grazing. The fiber is produced via an advanced closed loop solvent spinning process, with minimal impact on the environmental and economic aspect of energy and water. The solvent used in the process is 99% recoverable and is continually recycled. In certain embodiments, the cellulose fiber comprises nano-crystalline cellulose. In at least one embodiment, these are cellulosic fibers made from the incorporation of nano-crystalline cellulose extracted from trees and the balance of the fiber material from normal cellulosic fibers. In at least one embodiment, a portion of the cellulose fibers can be replaced with one or more natural fibers, such as natural wool fibers.

In at least certain embodiments, the cellulose fibers are blended with synthetic fibers. Examples of useful synthetic fibers include, but are not limited to, polyester fibers, flame retardant polyester fibers, nylon fibers, latex fibers, polyethylene fibers, polypropylene fibers, and combinations thereof. Flame resistant polyester fibers are made by combining flame retardants with polyester via a melting process then forming fibers. By combining the flame retardants with polymers via a melting process, the flame retardant chemicals are not readily released during normal use in the vehicle interior. Only if the polymer fibers melt are the chemicals released just in time to interfere with the burning process. The flame retardant fibers when mixed with other fibers can impart flame resistance to the overall material constructed. In at least one embodiment, the synthetic fibers comprise polyester fibers, where 60 weight percent of the fibers are PET of which 45 weight percent are regarded as recyclable because of the fact that these fibers are made from post consumer waste. The resultant material will be environmentally friendly, low mass and possibly low cost. In a refinement, the synthetic fibers are present in an amount ranging from 15 weight percent to 95 weight percent based on the total weight of the fiber section. In another refinement, the synthetic fibers are present in a combined amount ranging from 30 weight percent to 85 weight percent based on the total weight of the fiber section. In yet another refinement, the synthetic fibers are present in a combined amount ranging from 45 weight percent to 80 weight percent based on the total weight of the fiber section. In still yet another refinement, the synthetic fibers are present in a combined amount ranging from 50 weight percent to 70 weight percent based on the total weight of the fiber section.

In a variation of the present embodiment, the fiber layers 20, 28, and 36 set forth above includes a binder. Examples of suitable binders include, but are not limited to, bicomponent fiber binders, latex binders, chloroprene binders, thermoplastic materials, and combinations thereof. In a certain embodiment, the bicomponent fiber binder is a bicomponent polyester. Bicomponent polyester has a lower stiffness portion, with lower melt or softening point layer of material on the outer portion of the fiber and higher stiffness, higher melt or softening point material within the core of the fiber. This allows the material to be formed into a layer and also maintain the tear resistance strength required for durability. In a refinement, the binder is present in amounts ranging from 5 weight percent to 25 weight percent of the total weight of the fiber section. In another refinement, the binder is present in amounts ranging from 10 weight percent to 20 weight percent of the total weight of the fiber section.

In at least one embodiment, a suitable fiber blend comprises 20 weight percent to 60 weight percent renewable material, such as nano-crystalline cellulose fibers, 25 weight percent to 65 weight percent flame retardant treated polyester fibers, of which 40 weight percent to 80 weight percent is recycled; and 5 weight percent to 30 weight percent polyester bicomponent binder. In another embodiment, a suitable fiber blend comprises 30 weight percent to 50 weight percent renewable material, such as nano-crystalline cellulose fibers, 35 weight percent to 55 weight percent flame retardant treated polyester fibers, of which 55 weight percent to 70 weight percent is recycled; and 10 weight percent to 20 weight percent polyester bicomponent binder. In yet another embodiment, a suitable fiber blend comprises 40 weight percent renewable material, such as nano-crystalline cellulose fibers, 45 weight percent flame retardant treated polyester fibers, of which 63 weight percent is recycled; and 15 weight percent polyester bicomponent binder.

In a variation of the present embodiment, fibrous layers 20, 28 and 36 set forth above have a caliper thickness of from 1.0 mm to 20 mm. In a further refinement, fibrous pads fibrous layers 20, 28 and 36 set forth above have a caliper thickness of from 1.2 mm to 10 mm. In still a further refinement, fibrous layers 20, 28, and 36 set forth above have a caliper thickness of from 2.0 mm to 5.0 mm. In at least one embodiment, the fibrous layer is a layered system including both a knit layer and a non-woven layer secured to each other when formed. In at least one refinement, a layer of knit or woven material is made and then non-woven fibers are placed or positioned into this knitted layer or layers to build up the non-woven, internal layer. The non-woven layer provides loft and softness to the fibrous layer and the knit layer provides the tear resistance or durability required for seating applications.

In a variation of the present embodiment, the cellulosic and natural fibers are characterized by a denier from 1.0 dpf to 4.0 dpf. In another variation, the cellulosic and natural fibers are characterized by a denier from 1.5 dpf to 2.5 dpf. In still another refinement, the cellulosic and natural fibers each independently have a length from 3 mm to 12 mm. In yet another refinement, the cellulosic and natural fibers each independently have a length from 4.5 mm to 7.5 mm.

The present disclosure can be used to replace polyurethane foam where used in trim cover assemblies, and for instance in trim laminates. The thickness of the trim laminate in at least one embodiment is 2.5 to 12 mm, in another embodiment is 3 to 10 mm, and in yet another embodiment is 4 to 7 mm.

In another variation of the present embodiment, the fibrous layers 20, 28 and 36 further comprises a fire retardant fiber or treated polyester. Examples of suitable fire retardants include, but are not limited to, sodium borate, sodium or ammonium phosphates, phosphate esters, di-ammonium phosphate based flame retardants, sodium tetraborate decahydrate, and combinations thereof.

In at least one embodiment, the trim laminate includes a trim cover secured to a fibrous layer comprising 40 weight percent of renewable fiber and 60 weight percent of polyester. In another embodiment, the fibrous layer comprises 25 weight percent to 55 weight percent of renewable fiber and 45 weight percent to 75 weight percent of polyester. In yet another embodiment, the fibrous layer comprises 30 weight percent to 50 weight percent of renewable fiber and 50 weight percent to 70 wt. weight percent of polyester. In at least one variation, the fibrous layer comprises a composite having one or more non-woven layers secured to one or more woven layers, with the non-woven layer(s) comprising 20 to 40% of the thickness of the fibrous layer and the woven layer(s) comprising 80 to 60% of the thickness of the fibrous layer. In at least one embodiment, the renewable fibers are produced from a fiber made from wood pulp cellulose, which is harvested from tree-farmed trees. The tree farms have been established on land unsuitable for food crops or grazing. The fiber is produced via an advanced closed loop solvent spinning process, with minimal impact on the environmental and economical aspect of energy and water. The solvent used in the process is 99 weight percent recoverable and is continually recycled. On the other hand in polyester fibers, (PET) 85 weight percent of the fibers are regarded as sustainable because of the fact that these fibers are made from recycled PET bottles.

It is advantageous to use the trim laminate described herein in automotive seat trimming to replace petroleum-based seating trim laminate. The described trim laminate is environment friendly and recyclable material with number of benefits. Use of this material will make auto seats more environment friendly, and can also result in lower interior glass fogging potential, lower bacterial growth potential, faster drying rate, lower mass and lower cost.

Some benefits that may be appreciated by use of the fibrous layer as an underlay in a trim cover assembly as follows: sustainable, natural and renewable, environment friendly, anti-bacterial (reduced bacterial growth), heat absorbing, and moisture management. In at least certain embodiments, a fibrous layer comprising 30 weight percent renewable fibers and 70 weight percent polyester fibers absorbs 11 grams/meter more when compared to a layer of 100 weight percent polyester when short time absorption is measured. This characteristic contributes to the layer's ability to absorb water, sweat and humidity from the vehicle environment and then encourages faster evaporation and return to the air as opposed to remaining in the seating material where it can cause molding. Also, because the material fibers are oriented in a more vertical fashion when placed into a knitted layer as opposed to a layer formed from horizontally oriented fibers as is the case in traditional wet or dry laid sheets of polyester material, the end product has lower stiffness and better pliability so it can more easily bend to fit over the shape of curved seating foam. The addition of the flame resistant material was found to be beneficial for applications to help interior components achieve horizontal burn rate lower than 80 mm/min or a self-extinguishing sample to pass certain flammability

Using fibrous layers as an underlay in a trim cover assembly can enable the replacement of petroleum based polyurethane trim laminate in the auto seats, which may result in the following advantages: improved product environmental impact by raising the renewable resource content, green foot print, recyclability and sustainability, reduction of fogging, emission, and odor, seat comfort improvement, and possible weight and cost reductions.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A trim laminate for covering a cushion component, said trim laminate comprising:
a trim cover having a top surface and a bottom surface; and
a fibrous layer secured to the bottom surface of the trim cover, the fibrous layer comprising nano-crystalline cellulosic fibers and synthetic fiber.

2. The trim laminate of claim 1 wherein the cellulosic fibers are present in an amount ranging from 20 weight percent to 55 weight percent based on the total weight of the fibrous layer.

3. The trim laminate of claim 1 wherein the fibrous layer further comprises a binder.

4. The trim laminate of claim 3 wherein the binder is present in an amount from 5 weight percent to 25 weight percent of the total weight of the fibrous layer.

5. The trim laminate of claim 4 wherein the binder comprises a component selected from the group consisting of bicomponent fiber binders, latex binders, thermoplastic materials, and combinations thereof.

6. The trim laminate of claim 1 wherein the synthetic fibers comprise a component selected from the group consisting of polyester fibers, nylon fibers, latex fibers, polyethylene fibers, polypropylene fibers, and combinations thereof.

7. The trim laminate of claim 1 wherein the fibrous layer comprises a composite having a non-woven layer secured to a woven layer.

8. The trim laminate of claim 1 wherein the cover comprises a sheet layer made of a material selected from the group consisting of a non-woven fabric, a woven fabric, leather, a plastic sheet and combinations thereof.

9. The trim laminate of claim 8 wherein the trim laminate has a thickness of 2.5 to 12 mm.

10. The trim laminate of claim 9 wherein the cover is secured to the fibrous layer by at least one of threads and adhesive.

11. A seat assembly comprising a cushion and the trim laminate of claim 1, the trim laminate covering the cushion.

12. A cushion assembly for automotive interior components, the cushion assembly comprising:
a flexible foam cushion; and
a trim cover assembly supported on the foam cushion, the trim cover assembly comprising a trim cover, having a top surface and a bottom surface, and a fibrous layer secured to the bottom surface of the trim cover, the fibrous layer comprising 20 weight percent to 50 weight percent nano-crystalline cellulose fiber, 25 weight percent to 65 weight percent flame retardant treated polyester fiber, and 5 weight percent to 30 weight percent bicomponent fiber.

13. The cushion assembly of claim 12 wherein 40 weight percent to 80 weight percent of the flame retardant treated polyester is recycled polyester.

14. The cushion assembly of claim 12 wherein the trim cover assembly has a thickness of 2.5 to 12 mm.

15. The cushion assembly of claim 12 wherein the fibrous layer comprises a composite having a woven layer secured to a non-woven layer.

16. The cushion assembly of claim 12 wherein the cellulose fibers comprise nanofibrils having crystalline and amorphous regions.

17. A method of making a trim laminate, said method comprising:
providing a fibrous layer comprising nano-crystalline cellulose fiber and synthetic fiber; and
securing the fibrous layer to a trim cover.

18. The method of claim 17 wherein the trim cover comprises a component selected from the group consisting of a non-woven fabric, a woven fabric, leather, a plastic sheet and combinations thereof.

19. The method of claim 17 wherein the step of providing a fibrous layer comprises providing a plurality of fibrous sheets in a mold;
heating and compressing the plurality of fibrous sheets in the mold to adhere the sheets together to form the fibrous layer; and
removing the fibrous layer from the mold.

20. The method of claim 17 wherein the step of securing the fibrous layer to a trim cover comprises adhering and/or sewing the fibrous layer to the trim cover.
